(19) United States
(12) Patent Application Publication
(10) Pub. No.: US 2019/0289020 A1
(43) Pub. Date: Sep. 19, 2019

(54) PROVISION OF SECURE COMMUNICATION IN A COMMUNICATIONS NETWORK CAPABLE OF OPERATING IN REAL TIME

(71) Applicant: Siemens Aktiengesellshaft, München (DE)

(72) Inventors: Markus Heintel, München (DE); Kai Fischer, Baldham (DE)

(21) Appl. No.: 16/340,924

(22) PCT Filed: Sep. 12, 2017
(86) PCT No.: PCT/EP2017/072801

§ 371 Date: Apr. 10, 2019

(30) Foreign Application Priority Data
Oct. 12, 2016 (DE) 10 2016 219 848.3

(51) Int. Cl. H04L 29/06; H04L 9/06

(52) U.S. Cl. CPC H04L 63/123; H04L 63/20; H04L 63/0227; H04L 63/1441; H04L 9/0643; H04L 63/1408; H04L 63/08

(57) ABSTRACT

Provided is a device for integrity checking, which is used to provide secure communication between at least two communication partners inside a communications network capable of operating in real time, particularly in the environment of industrial production and/or automation, the device including: a unit for receiving a formed first integrity reference value for at least one isolated message and/or for receiving at least one formed second integrity reference value for at least one isolated message; a unit for correlating the first integrity reference value with the at least second integrity reference value and for comparing same; and a unit for emitting a warning and/or alarm signal, which is provided for a position initiating corresponding counter-measures when the correlated integrity reference values deviate from each other.

### CROSS-REFERENCE TO RELATED APPLICATIONS

This application claims priority to PCT Application No. PCT/EP2017/072801, having a filing date of Sep. 12, 2017, based on German Application No. 10 2016 219 848.3, having a filing date of Oct. 12, 2016, the entire contents both of which are hereby incorporated by reference.

### FIELD OF TECHNOLOGY

The present embodiments of the invention relate to a method, a device and a communication system for the provision of secure communication in a communications network capable of operating in real time, specifically in the context of industrial production and/or automation, together with an associated computer program (product).

### BACKGROUND

In state-of-the-art automated installations, IT systems are employed for the control of manufacturing processes or individual process steps. In an installation of this type, in order to permit the communication of field devices such as sensors and controlling elements (actuators) with an automation device, a “field bus” is employed by way of a communication bus system. Communications are governed by standardized protocols, e.g. IEC 61158. Ethernet-based field buses with real-time operating capability are available, and are summarized e.g. in IEC standard 61784-2. Commonly employed real-time-capable field buses include Profibus and Profinet, Ethercat and Modbus.

The security of industrial field bus protocols is essential in an industrial production environment. The (cryptographic) protection of mutually-communicating components, such as plants or devices, plays an increasingly important role in the guaranteed maintenance of secure operation. By means of cryptographic functions, objectives such as the integrity, confidentiality or authenticity of components can be achieved. Protection against deliberate and targeted attacks is provided accordingly.

The concept of “security” essentially relates to the security, confidentiality and/or integrity of data and the transmission thereof, and to security, confidentiality and/or integrity in conjunction with access to said data. Authentication associated with data transmissions or data access is also included inter alia in the concept of “security”. A cryptographic functionality is generally understood, for example, as a function for the encryption, the protection of confidentiality, the protection of integrity and/or the authentication of data (e.g. user data, control data, configuration data or administrative data). The cryptographic protection functionality can, for example, incorporate one or more of the functionalities listed hereinafter:
Encrypted storage
System and/or user authentication
Certification
Encryption
Decryption
Calculation of a cryptographic checksum (e.g. signature)
Verification of a cryptographic checksum (e.g. signature)
Key agreement
Key generation
Generation of random numbers (e.g. seed generation)
Licensing
Support of systemic monitoring functions (e.g. tamper-proofing, system integrity, STEM)
Supervision or monitoring of data
Validation of data
Filtering of data.

Each of the cryptographic functionalities listed can, in turn, be executed in combination with other/further processes or combinations of said processes.

A data interface for data transmission or communication between the above-mentioned components can, for example, be a wired or wireless interface (e.g. a mobile telephony interface (GSM, UMTS, LTE), a WLAN, Bluetooth, Zigbee (specifically employed in home automation) or NFC interface (NFC: Near Field Communication)). The data interface can be configured and set-up as a serial or parallel data interface. Communication between components is not restricted to point-to-point (peer) communications. Group communication, broadcast message or publish/subscribe communication models are also conceivable.

By the manipulation of fieldbus messages, also described as telegrams, for example, the quality of works or goods produced can be influenced, individual production components can be destroyed, or a plant can be brought to a standstill. As digitization increases, involving the use of digital ethernet-based fieldbus protocols such as Profinet I/O, Ethercat or Modbus, so attacks on the network infrastructure and the manipulation of fieldbus telegrams have become considerably easier.

One measure for the step-wise reliability classification of industrial components and machines involves the division thereof into different zones (zonal model). In general, no further protective measures are applied within any one such zone. Zones are generally configured such that communication occurs between components within the zone, and communication with components outside the same zone is only possible under conditional circumstances. Content, or node points, or components within the zone are protected, and dedicated transfer points to other zones are provided. Examples of such zonal models are as follows:
Cellular protection concept in the Profinet Security Guideline, version 2.0/chapter 10.2
Conduits and zones in IEC 62443
NIST-SP 800-82 Guide to Industrial Control Systems.

In the context of future industrial 4.0 scenarios, cellular protection concepts of this type will no longer be appropriate, as communications are increasingly executed across zone boundaries. Transfer points of this type frequently delay the flow of data, thereby influencing real-time performance.

In conventional IT networks, TLS (Transport Layer Security) or IPSec (Internet Protocol Security) are frequently employed as security protocols. TLS—as its full name indicates—is defined on level 4 (layer 4, or the transport layer) and IPSec on level or layer 3 (network layer) of the OSI reference model applied in communication technology.

Ethernet protocols, together with the above-mentioned fieldbus protocols, are employed on level 2 of the OSI reference model. The “security layer” (layer 2) is generally responsible for error-free data transmission and, where applicable, for data flux controls on the transmitter and receiver side. Message or data streams are customarily subdivided into blocks (also described as frames). By the use of checksums, only defective data transmission can be detected. There is no protection against active manipulation. Current fieldbus protocols incorporate no security measures, other than the above-mentioned zonal model.

In this context, the issue arises of the greater impact of (cryptographic) security measures upon time response, the higher they are executed in an OSI layer/level. Accordingly, they are not appropriate for real-time-capable communication protocols such as e.g. Profinet. Moreover, it is intended that protocols on levels 1 and 2 of the OSI reference model should remain unchanged, with no extension for the incorporation of cryptographic data, such that these protocols can continue to be used.

From DE 10 2010 033 229 A1, a method and a system for the manipulation-proof transmission of control data via a transmission network are known. These control data can be transmitted “inband”, in the same network, or “outband”, i.e. separately in the same network, from a control unit of a first control network to a second control unit of a second control network. As the control networks are coupled to the transmission network via gateways (transfer point), the scenario disclosed in this document is similar to the above-mentioned zonal model.

In DE 102015218373.4, a method for monitoring the integrity of a distributed system has been proposed. Herein, in a sampling arrangement, a test data record is determined, which is dependent upon a data record which is to be transmitted via a communication link of the distributed system. Moreover, the cryptographically protected test data record is delivered to a test unit, wherein the transmission of the data record via the communication link is uninfluenced by the determination and the delivery thereof, and wherein the cryptographically protected test data record is checked for integrity by the test unit, with reference to cryptographic calculations and plausibility information. In this case, the primary focus is on a low-selective sampling method. However, integrity checking should be applied to targeted messages, rather than sample messages.

### SUMMARY

An aspect relates to the provision of targeted, real-time-capable security or protective measures for communication protocols below level 3 of the OSI reference model, specifically industrial fieldbus protocols, with no intervention in the communication protocol.

The embodiments of the invention include a method for providing secure communication between at least one first communication partner and at least one second communication partner within a communication network capable of operating in real time, particularly in the context of industrial production and/or automation, comprising the following steps:
Provision of at least two interfaces, each of which is or can be assigned to a communication partner;
Isolation of at least one message transmitted and/or received between the communication partners at the respectively associated interface, by means of at least one definable filtering criterion, wherein the at least one isolated message undergoes an integrity check;
Wherein, for the purposes of integrity checking, a first integrity reference value for at least one isolated message transmitted and/or received by the first communication partner, and at least one second integrity reference value for at least one isolated message received and/or transmitted by at least the second communication partner are constituted;
Provision of a test unit for integrity checking;
Correlation of the first integrity reference value with the second integrity reference value, and comparison of same by the test unit;
Generation of a warning and/or alarm signal by the test unit, or the referral of the warning and/or alarm signal originating from the test unit to an authority responsible for the deployment of corresponding counter-measures, in the event that the correlated integrity reference values deviate from each other.

The first and second integrity reference values can deviate from each other, to the extent that they lie outside a definable tolerance range. In the communication network, a plurality of communication partners are conceivable. The embodiments of the invention are not limited to point-to-point communication, but can also be employed for point-to-multipoint communication (broadcast). It is also conceivable that a plurality of test units are arranged in the communication network, each of which assumes the integrity check for a subregion of the communication network and, where applicable, are coordinated by a further superordinate unit.

The embodiments of the invention have an advantage, in that they permit the detection of and defense against attacks by an unauthorized party who is endeavoring to access works or devices. Additionally, the integrity of messages can thus be monitored, with no resulting impact upon time response.

The embodiments of the invention provide a further advantage, in that the embodiments are not limited to the above-mentioned zone but, where applicable, can be employed at a plurality of transfer points. Moreover, the test unit does not monitor messages themselves, but only correlates and checks the integrity reference values, thus permitting the reduction of the network load. By means of the type of integrity checking according to the embodiments of the invention, confidential/sensitive information can also be checked.

According to a further development of the embodiments of the invention, it is provided that, for communication between the communication partners, a communication protocol below level 3, also described as the network layer in the OSI reference model applied in communication technology, is employed. For communication between the communication partners, a fieldbus communication protocol can also be employed.

Specifically, according to the embodiments of the invention, an “out-of-band” integrity check is applied, with no necessity for intervention in the fieldbus protocol employed. Accordingly, the early detection of attacks is possible.

According to a further development of the embodiments of the invention, it is provided that at least one filtering criterion relates to the message type, the sender and/or receiver, a random message filtering function, a bandwidth and/or network load and/or a filterable message content, and/or any combination thereof.

According to a further development of the embodiments of the invention, it is provided that the above-mentioned interfaces undertake the passive monitoring of transmitted and/or received messages. Accordingly, interfaces including those described as security interfaces have no influence upon the flux of messages.

Monitoring or filtering criteria can be flexibly configured in an interface filtering unit (which can also be configured in the form of security sensors) and adapted in a context-specific manner. Filtering criteria can be synchronously applied by the test unit.

The first integrity reference value can comprise a plurality of integrity reference values and/or the second integrity reference value can likewise comprise a plurality of integrity reference values. Integrity reference values of this type can each comprise a hash value of an isolated sent/received message and/or elements thereof, and/or an accumulation of a plurality of filtered messages and/or elements thereof.

According to a further development of the embodiments of the invention, it is provided that the at least one first integrity reference value, from a definable time window, is compared with at least the second correlating integrity reference value from the same time window.

According to a further development of the embodiments of the invention, it is provided that communication between the communication partners and communication between the respective interface and the test unit are executed in mutually independent channels.

According to a further aspect of the embodiments of the invention, a device for integrity checking is provided, which is suitable for the provision of secure communication between at least two communication partners within a communication network capable of operating in real time, specifically in the context of industrial production and/or automation, comprising:
a unit for receiving a formed first integrity reference value for at least one isolated message and/or for receiving at least one formed second integrity reference value for at least one isolated message;
a unit for correlating the first integrity reference value with the at least second integrity reference value, and for comparing same; and
a unit for emitting a warning and/or alarm signal, which is delivered to an authority responsible for the deployment of corresponding counter-measures, in the event that the correlated integrity reference values deviate from each other.

The device can be configured or further developed in accordance with the forms of embodiment/further developments of the above-mentioned method.

The above-mentioned test unit can be configured as the above-mentioned device for integrity checking.

According to a further aspect of the embodiments of the invention, an arrangement is provided, specifically a communication arrangement or communication system for the provision of secure communication between at least two communication partners within a communication network capable of operating in real time, specifically in the context of industrial production and/or automation, comprising at least two security interfaces which are assigned to the communication partners, each having at least one unit for the constitution of an integrity reference value for a sent and/or received message, and for the transmission of the integrity reference value to at least one integrity reference value checking device of the above-mentioned type, also described as a test unit.

A unit for the isolation of at least one transmitted and/or received message between the communication partners on the basis of at least one definable filtering criterion can moreover be assigned to each security interface, wherein the at least one filtering criterion is synchronizable by means of the above-mentioned device.

The security interface which is assigned to the message-receiving communication partner and/or which is assigned to the message-transmitting communication partner can moreover comprise a unit for the reception of an integrity value comparison result from the above-mentioned device.

The security interface can moreover comprise an output unit for the delivery of a warning and/or alarm signal to an authority for the initiation of corresponding counter-measures, depending upon the integrity value comparison result.

The communication system can be configured or further developed in accordance with the forms of embodiment/further developments of the above-mentioned device and/or the above-mentioned method.

The above-mentioned units can be implemented in software, firmware and/or hardware. These can be understood in the manner of functional units, the function of which can be integrated in any desired combination with that of an individual unit.

A further aspect of the embodiments of the invention can comprise a computer program or computer program product (non-transitory computer readable storage medium having instructions, which when executed by a processor, perform actions), having means for the execution of the method and the above-mentioned configurations thereof, where the computer program (product) or the at least one computer program is distributed for execution within the communication system of the above-mentioned type.

The above-mentioned devices, systems and, where applicable, the computer program (product) can essentially be configured or further developed in an analogous manner to the method and the configurations or further developments thereof.

### BRIEF DESCRIPTION

Some of the embodiments will be described in detail, with references to the following Figures, wherein like designations denote like members, wherein:

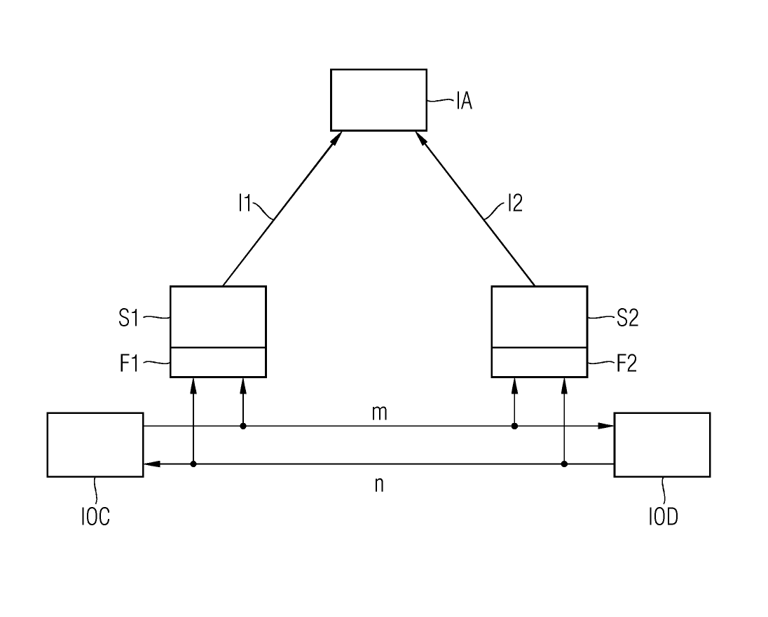

FIG. 1: illustrates a method according to the embodiments of the invention for integrity checking in a fieldbus communication.

### DETAILED DESCRIPTION

According to FIG. 1, an IO controller IOC exchanges messages m, n with an IO device IOD, for example via a communication network, e.g. Profinet IRT. The IO controller IOC transmits, for example, a message m (Profinet IRT telegram) to the IO device. The security interface S1 which is assigned to the IO controller, where applicable configured as a sensor, scans the message m and, with reference to (filtering) rules, which can be implemented in a filtering function F1, decides on the activation of an integrity check for the message m.

The filtering function can comprise rules for the checking or monitoring of messages. It can thus be established:
which message type (e.g. Profinet messages only, rather than http messages) is to be monitored;
which message from which sender(s) or for which receiver(s) is to be monitored;
whether messages are to be monitored randomly, or in accordance with a definable condition (e.g. bandwidth/network load),
what message content is to be monitored with reference to definable filtering masks or templates, etc.

The security interface or the security sensor S1 calculates an integrity reference value I1, and transmits the latter to a test unit IA, also described as an Integrity Authority. Before any mutual communication between the IOC and the IOD, a secure connection with the test unit IA is constituted, and authentication is completed therein.

The IO device IOD receives the message m, and can process the latter. The security interface S2 assigned to the IO device IOD, where applicable configured as a sensor, scans the message m and, with reference to (filtering) rules, which can be implemented in a filtering function F2, decides on the activation of an integrity check for the message m. Preferably, the security sensors S1 and S2 are configured passively. They execute a read-only function, and have no further impact upon the communication between the IOC and the IOD. Accordingly, there is no negative influence upon the real-time capability of the communication between the IOC and the IOD.

The security interface or the security sensor S2 calculates an integrity reference value I2, and transmits the latter to the test unit IA. The test unit executes the mutual comparison of the integrity reference values I1 and I2 and, in the event of any inequality in these values, can detect a potential manipulation.

The integrity reference values constitute the integrity of messages exchanged between the communication partners or components, for example the IOC and the IOD. In order to permit the test unit IA to generate a statement or an evaluation with respect to integrity status, integrity checking can incorporate “plausibility data” such as, e.g. projection data, configuration data and/or the physical properties of components. Plausibility data can further comprise precalculated data, e.g. derived from a simulation. Likewise, any data present in real time, or redundant data, which may originate from “digital twinning data”, can be mutually cancelled out. A number of types of integrity checking can be combined, by the use of various plausibility data.

The integrity check can be executed with a time delay in a down-circuit arrangement. In general, in a production environment, a warning message or a security alarm is triggered upon the detection of any manipulated messages. Production can then continue until such time as, in response to the warning message or security alarm, an appropriate counter-measure is established, where applicable by an external authority for the initiation of counter-measures (not represented in FIG. 1). The integrity check can be specifically adapted to context at any time.

Moreover, the integrity and authenticity of integrity reference values should also be protected on the communication path between the security sensor S1, S2 and the test unit IA. This communication can be executed via an independent channel, for which purpose conventional IP-based communication protocols such as, e.g. TLS or IPSec can be employed.

Integrity reference values can be pure hash values (unit functions) of the transmitted/received message or elements of the message, or the hash value of an accumulation of messages. In addition to an integrity checksum, the integrity reference value can also incorporate data, such as e.g. time stamps or frame counter values, which are required for the correlation or classification of the integrity reference values I1 and I2 by the test unit. Information on the message history can also be incorporated in the integrity value. It is also conceivable for integrity reference values to be generated from confidential information, without the necessity for any disclosure of plain text to the security sensor of the test unit.

If a clear correlation is not readily possible on the grounds of marginal conditions, such as e.g. the hardware, network or logic addresses of the mutually communicating components, or the hash values thereof, a time window-based approach can be employed. A time window is defined as a time interval T having a start time a and an end time e. The quantity of integrity reference values I1 [ ] from a given time window T0=[s0 . . . e0] must coincide with the quantity of integrity reference values I2 [ ] from the same time window. Time windows can be applied sequentially, disjunctively, or in an overlapping manner.

The correlation between the integrity reference values I1 and I2 can also be executed, wherein a filtering criterion or a plurality of filtering criteria of the filtering functions F1 and F2 are synchronized by the test unit, which can define said filtering criteria. It can thus be ensured that integrity values of the same message, e.g. m, or at least of the same message type etc., are mutually compared.

In a further configuration, it is required that the communication partners, in communication with the test unit, are authenticated by the latter. Authentication information can include information with respect to the security level (e.g. SL-1 to SL-4, according to IEC 62443), such that the test unit can establish whether the two communication partners, for example S1 with IOC and S2 with IOD, have the same security level, or whether e.g. data from a device with a higher security level are being transmitted to a device with a lower security level, or vice versa.

Authorized communication partners on the communication path between the IOC and the IOD may/can legitimately modify messages. Any such modification can then be notified to the test unit IA. Any breach of integrity between the IOC and the IOD can thus be legitimized by the test unit IA.

Although the embodiments of the invention have been illustrated and described in greater detail by detailed reference to the preferred exemplary embodiment, the invention is not limited to the examples disclosed, and further variations can be inferred by a person skilled in the art, without departing from the scope of protection of the embodiments of the invention.

Implementation of the above-mentioned processes or process sequences can be executed with reference to instructions, which are present on machine-readable storage media or in volatile computer memories (described in brief hereinafter as machine-readable memories). Machine-readable memories include, for example, voltage memories such as cache memory, buffer memory or RAM, and non-volatile memories such as removable storage devices, hard disks, etc.

The above-mentioned functions or steps can be present in the form of at least one set of instructions in/on a machine-readable memory. Said functions or steps are not tied to a specific set of instructions or a specific form of sets of instructions, or to a specific storage medium, or to a specific processor, or to specific execution arrangements, but can be executed by means of software, firmware, microcode, hardware, processors, integrated circuits, etc., in individual operation or in any desired combination. Accordingly, the most diverse processing strategies can be employed, for example serial processing using a single processor, multiprocessing or multitasking, or parallel processing, etc.

Although instructions can be saved in local memories, it is also possible for instructions to be saved on a remote system, and accessed via a network.

The terms “processor”, “central signal processing”, “control unit” or “data evaluation means”, as employed in the present context, encompass processing means in the broadest sense, including, for example, servers, universal processors, graphics processors, digital signal processors, application-specific integrated circuits (ASICs), programable logic circuits such as FPGAs, discrete analog or digital circuits or any combinations thereof, including all other processing means which are known to a person skilled in the art, or which are developed in future. Processors can comprise one or more devices, or mechanisms, or units. If a processor is comprised of a plurality of devices, these can be designed or configured for the parallel or sequential processing or execution of instructions.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for providing secure communication between at least one first communication partner and at least one second communication partner within a communication network capable of operating in real time, the method comprising:
providing at least two interfaces, each of which are assigned to a communication partner;
isolating at least one message transmitted and/or received between the communication partners at the respectively associated interface, by means of at least one definable filtering criterion, wherein the at least one isolated message undergoes an integrity check;
for the purposes of integrity checking, constituting a first integrity reference value for at least one isolated message transmitted and/or received by the first communication partner, and at least one second integrity reference value for at least one isolated message received and/or transmitted by at least the second communication partner;
providing a test unit for integrity checking;
correlating the first integrity reference value with the second integrity reference value, and comparing of same by the test unit; and
generating a warning and/or alarm signal by the test unit, or the referral of the warning and/or alarm signal originating from the test unit to an authority responsible for the deployment of corresponding counter-measures, in the event that the correlated integrity reference values deviate from each other.

2. The method as claimed in claim 1, wherein, for communication between the communication partners, a communication protocol below level 3, also described as the network layer in the OSI reference model applied in communication technology, is employed.

3. The method as claimed in claim 1, wherein, for communication between the communication partners, a fieldbus communication protocol is employed.

4. The method as claimed in claim 1, wherein the at least one filtering criterion relates to the message type, the sender and/or receiver, a random message filtering function, a bandwidth and/or network load and/or a filterable message content, and/or any combination thereof.

5. The method as claimed in claim 1, wherein the at least two interfaces undertake a passive monitoring of transmitted and/or received messages.

6. The method as claimed in claim 1, wherein, as an integrity reference value, a hash value of an isolated sent/received message and/or elements thereof, and/or an accumulation of a plurality of filtered messages and/or elements thereof is employed.

7. The method as claimed in claim 1, wherein the at least one first integrity reference value from a definable time window is compared with at least the second correlating integrity reference value from the same time window.

8. The method as claimed in claim 1, wherein the communication between the communication partners and the communication between the respective interface and the test unit are executed in mutually independent channels.

9. A device for integrity checking, which is suitable for the provision of secure communication between at least two communication partners within a communication network capable of operating in real time, the device comprising:
a unit for receiving a formed first integrity reference value for at least one isolated message and/or for receiving at least one formed second integrity reference value for at least one isolated message;
a unit for correlating the first integrity reference value with the at least second integrity reference value, and for comparing same; and
a unit for emitting a warning and/or alarm signal, which is delivered to an authority responsible for the deployment of corresponding counter-measures, in the event that the correlated integrity reference values deviate from each other.

10. The device as claimed in claim 9, wherein correlation involves an association of the first integrity value with the at least second integrity value, with respect to the same isolated message which is transmitted between the communication partners.

11. The device as claimed in claim 9, wherein the at least one first integrity reference value from a definable time window is compared with at least the second correlating integrity reference value from the same time window.

12. The device as claimed in claim 9, wherein the device comprises at least one unit for synchronizing the isolation of at least one transmitted and/or received message between the communication partners, with reference to at least one definable filtering criterion.

13. The device as claimed in claim 9, wherein, for communication between the communication partners, a communication protocol below level 3, also described as the network layer in the OSI reference model applied in communication technology, is employable.

14. The device as claimed in claim 9, wherein, for communication between the communication partners, a fieldbus communication protocol is employable.

15. The device as claimed in claim 9, wherein the at least one definable filtering criterion relates to the message type, the sender and/or receiver, a random message filtering function, a bandwidth and/or network load and/or a filterable message content, and/or any combination thereof.

16. The device as claimed in claim 9, wherein, as an integrity reference value, a hash value of the isolated message and/or elements thereof, and/or an accumulation of a plurality of filtered messages and/or elements thereof is employable.

17. The device as claimed in claim 9, wherein at least one channel for communication between the communication partners and at least one channel for the reception of the at least one first and/or the at least second integrity value are mutually independent.

18. The device as claimed in claim 9, wherein, for integrity checking, plausibility data, specifically projection data and/or configuration data and/or physical properties of the communication partners, data derived from a simulation and/or digital twinning data can be incorporated.

19. A communication system for providing secure communication between at least two communication partners within a communication network capable of operating in real time, comprising at least two interfaces which are assigned to the communication partners, each having at least one unit for the constitution of an integrity reference value for a sent and/or received message, and for the transmission of the integrity reference value to at least one integrity reference value checking device as claimed in claim 9.

20. The communication system as claimed in claim 19, wherein a unit for the isolation of at least one transmitted and/or received message between the communication partners on the basis of least one definable filtering criterion is further assigned to each interface, wherein the at least one filtering criterion is synchronizable by means of the least one integrity reference value checking device.

21. The communication system as claimed in claim 19, wherein the interface which is assigned to the message-receiving communication partner and/or which is assigned to the message-transmitting communication partner can moreover comprise a unit for the reception of an integrity value comparison result from the least one integrity reference value checking device.

22. The communication system as claimed in claim 21, wherein the interface further comprises an output unit for the delivery of a warning and/or alarm signal to an authority for the initiation of corresponding counter-measures, depending upon the integrity value comparison result.

23. The communication system as claimed in claim 19, wherein the interfaces are configured passively.

24. The communication system as claimed in claim 19, wherein, for communication between the communication partners, a communication protocol below level 3, also described as the network layer in the OSI reference model applied in communication technology, is employable.

25. The communication system as claimed in claim 19, wherein, for communication between the communication partners, a fieldbus communication protocol is employable.

26. The communication system as claimed in claim 19, wherein the communication between the communication partners and the communication between the respective interface and the device for integrity checking can be executed in mutually independent channels.

27. A computer program product comprising a computer readable hardware storage device having computer readable program code stored therein, said program code executable by a processor of a computer system to implement a method. at least one computer program, having means for the execution of the method as claimed in claim 1.
